(19) United States
(12) Patent Application Publication
(10) Pub. No.: US 2023/0401530 A1
(43) Pub. Date: Dec. 14, 2023

(54) MANAGEMENT APPARATUS, ELECTRONIC SHELF LABEL, AND MANAGEMENT METHOD

(71) Applicant: NEC Corporation, Minato-ku, Tokyo (JP)

(72) Inventors: Jun UCHIMURA, Tokyo (JP); Hiroki Sugegaya, Tokyo (JP)

(73) Assignee: NEC Corporation, Minato-ku, Tokyo (JP)

(21) Appl. No.: 18/036,130

(22) PCT Filed: Nov. 16, 2020
(86) PCT No.: PCT/JP2020/042662

§ 371 Date: May 9, 2023

(51) Int. Cl. G06Q 10/087

(52) U.S. Cl. CPC G06Q 10/087

(57) ABSTRACT

One of objects of the present invention is to reduce labor of a user when placing an electronic shelf label (103) on a fixture (104). The present invention includes: one or a plurality of electronic shelf labels (103); and a management apparatus (107) that manages the one or a plurality of electronic shelf labels (103). The management apparatus (107) includes: a product ID acquisition unit (120) that acquires, when accepting exhibition area information for identifying an exhibition area of one or a plurality of products, product information of the one or a plurality of products relevant to a product ID associated with the accepted exhibition area information in information in which exhibition area information and product identification information are associated with each other; and a second control unit (122) that performs control for associating each of the one or a plurality of pieces of product information with the one or a plurality of electronic shelf labels (103).

### TECHNICAL FIELD

The present invention relates to a management apparatus, an electronic shelf label, a management system, a management method, and a program.

### BACKGROUND ART

An electronic shelf label is being generally used in a store such as a supermarket or a convenience store. The electronic shelf label is placed in association with a product exhibited on a product shelf of a fixture or the like, and displays product information of the associated product (for example, see PTL 1).

### RELATED DOCUMENT

### Patent Document

[PTL 1] Japanese Patent Application Publication No. 2016-140368

### SUMMARY OF THE INVENTION

Technical Problem

Incidentally, in general, since a plurality of products are handled in a store, a plurality of electronic shelf labels are often used as well. Further, a plurality of fixtures are installed, and each of the fixtures often includes a plurality of product shelves as well. Thus, when placing a plurality of electronic shelf labels on a fixture, it takes a large amount of labor to find out and place an electronic shelf label to be placed on each placement position.

The present invention has been made in view of the above-described circumstance, and one of objects of the present invention is to reduce labor of a user when placing an electronic shelf label on a fixture.

### Solution to Problem

In order to accomplish the above object, a management apparatus according to a first viewpoint of the present invention includes:

a product identification information acquisition means for acquiring, when accepting exhibition area information for identifying an exhibition area of one or a plurality of products, product information of the one or a plurality of products relevant to product identification information associated with the accepted exhibition area information in information in which exhibition area information and product identification information are associated with each other; and

a control means for performing control for associating each of the one or a plurality of pieces of acquired product information with one or a plurality of display apparatuses.

An electronic shelf label according to a second viewpoint of the present invention includes:

a shelf label storage means for storing product information and shelf label placement information indicating a position to be placed; and

a shelf label display control means for causing a shelf label display means to display the shelf label placement information, wherein

the shelf label placement information is fixture identification information for identifying a fixture on which the product is exhibited, shelf identification information for identifying a shelf provided in each of the fixtures, or exhibition position information indicating an exhibition position of a product.

A management system according to a third viewpoint of the present invention includes:

one or a plurality of electronic shelf labels; and

a management apparatus that manages the one or a plurality of electronic shelf labels, wherein

the management apparatus includes
a product identification information acquisition means for acquiring, when accepting exhibition area information for identifying an exhibition area of one or a plurality of products, product information of the one or a plurality of products relevant to product identification information associated with the accepted exhibition area information in information in which exhibition area information and product identification information are associated with each other, and
a registration control means for performing control for associating each of the one or a plurality of pieces of product information with the one or a plurality of electronic shelf labels.

A management method according to a fourth viewpoint of the present invention includes:

acquiring, when accepting exhibition area information for identifying an exhibition area of one or a plurality of products, product information of the one or a plurality of products relevant to product identification information associated with the accepted exhibition area information in information in which exhibition area information and product identification information are associated with each other; and

performing control for associating each of the one or a plurality of pieces of acquired product information with one or a plurality of display apparatuses.

A program according to a fifth viewpoint of the present invention causes a computer to execute:

acquiring, when accepting exhibition area information for identifying an exhibition area of one or a plurality of products, product information of the one or a plurality of products relevant to product identification information associated with the accepted exhibition area information in information in which exhibition area information and product identification information are associated with each other; and

performing control for associating each of the one or a plurality of pieces of acquired product information with one or a plurality of display apparatuses.

### Advantageous Effects of Invention

According to the present invention, labor of a user when placing an electronic shelf label on a fixture can be reduced.

### BRIEF DESCRIPTION OF THE DRAWINGS

FIG. 1 is a diagram illustrating a configuration of a management system according to one example embodiment of the present invention.

FIG. 2 is a diagram illustrating one example of a layout of fixtures in a store.

FIG. 3 is a diagram illustrating one example of a configuration of a shelf of a fixture and exhibition of a product in the fixture.

FIG. 4 is a diagram illustrating a functional configuration of an electronic shelf label according to one example embodiment.

FIG. 5 is a diagram illustrating a functional configuration of a management apparatus according to one example embodiment.

FIG. 6 is a diagram illustrating one example of product management information according to one example embodiment.

FIG. 7 is a diagram illustrating a physical configuration of the management apparatus according to one example embodiment.

FIG. 8 is a diagram illustrating a physical configuration of the electronic shelf label according to one example embodiment.

FIG. 9 is a flowchart illustrating one example of a management method according to one example embodiment of the present invention.

FIG. 10 is a diagram illustrating product management information according to one example embodiment, the product management information being before a shelf label ID is set.

FIG. 11 is a flowchart illustrating one example of association processing included in the management method illustrated in FIG. 9.

FIG. 12 is a flowchart illustrating one example of an electronic shelf label control method according to one example embodiment of the present invention.

FIG. 13 is a diagram illustrating one example of shelf label product information according to one example embodiment.

FIG. 14 is a diagram illustrating one example of shelf label placement information according to one example embodiment.

FIG. 15 is a flowchart illustrating one example of display switching processing included in the electronic shelf label control method illustrated in FIG. 12.

FIG. 16 is a diagram illustrating one example of product information and shelf label placement information switchingly displayed on the electronic shelf label.

FIG. 17 is a diagram illustrating one example of product exhibition information constituting product management information according to a modified example 3.

FIG. 18 is a diagram illustrating one example of product exhibition information constituting exhibition position information according to the modified example 3.

### DESCRIPTION OF EMBODIMENTS

Hereinafter, an example embodiment of the present invention will be described by using the drawings. Note that, a similar component is assigned with a similar reference sign throughout all the drawings, and description therefor will be omitted as appropriate.

### Configuration of Shelf Label Management System 100

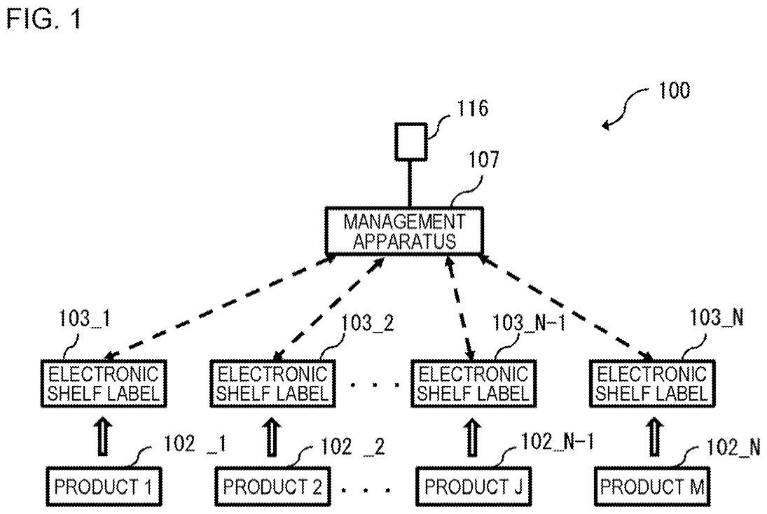

A management system 100 according to one example embodiment of the present invention is a system for managing products 102_1 to 102_N being sold in a store 101 and electronic shelf labels 103_1 to 103_N respectively associated with the products 102_1 to 102_N, as illustrated in FIG. 1. Note that, N is an integer equal to or more than 6 in the present example embodiment, but may be an integer equal to or more than 1.

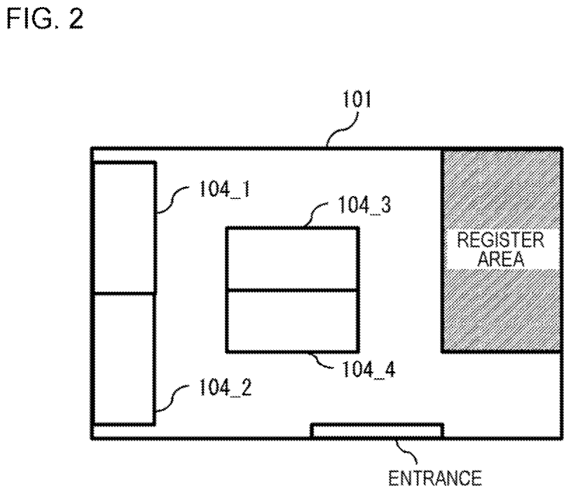

The store 101 is a supermarket, a convenience store, or the like. In the store 101, fixtures 104_1 to 104_4 for exhibiting the products 102_1 to 102_N are installed, as illustrated in a plan view in FIG. 2. FIG. 2 is a diagram illustrating one example of a layout of the fixtures 104_1 to 104_4 in the store 101 according to the present example embodiment. Note that, the number of fixtures installed in the store 101 is not limited to 4. but may be 1 or more.

The fixtures 104_1 to 104_4 are allocated product exhibition positions 105_1 to 105_N being ranges where the products 102_1 to 102_N are exhibited, and the mutually different products 102_1 to 102_N are exhibited in the product exhibition positions 105_1 to 105_N.

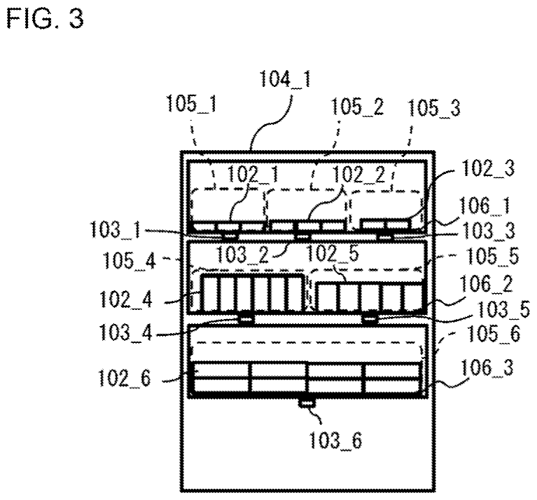

Herein, one example of product exhibition positions 105_1 to 105_6 allocated to the fixture 104_1 is illustrated in a front elevational view of the fixture 104_1 in FIG. 3. The fixture 104_1 includes three shelves 106_1 to 106_3, as illustrated in FIG. 3.

The shelf 106_1 is allocated three product exhibition positions 105_1 to 105_3. The shelf 106_2 is allocated two product exhibition positions 105_4 to 105_5. The shelf 106_3 is allocated one product exhibition position 105_6.

Electronic shelf labels 103_1 to 103_6 are attached to the fixture 104_1 in respective vicinities of products 102_1 to 102_6, thereby being placed in association with the respective products 102_1 to 102_6.

FIG. 3 illustrates an example in which the electronic shelf labels 103_1 to 103_6 are attached to the shelves 106_1 to 106_3 at respective front portions of the product exhibition positions 105_1 to 105_6. The electronic shelf labels 103_1 to 103_6 display, as display apparatuses, product information (a product name, a price, and the like) of the products 102_1 to 102_6 associated therewith.

The fixtures 104_2 to 104_4 are also allocated product exhibition positions 105_7 to 105_N for exhibiting products 102_7 to 102_N, similarly to the fixture 104_1. Then, electronic shelf labels 103_7 to 103_N are attached to vicinities of the products 102_7 to 102_N relevant thereto, and display a product name, a price, and the like of the relevant products 102_7 to 102_N. However, part or whole of the fixtures 104_2 to 104_4 may not include a shelf.

The management system 100 includes the electronic shelf labels 103_1 to 103_N and a management apparatus 107 that manages the products 102_1 to 102_N and the electronic shelf labels 103_1 to 103_N, as illustrated in FIG. 1. Each of the electronic shelf labels 103_1 to 103_N and the management apparatus 107 transmit and receive information to and from each other by, for example, wireless communication such as Bluetooth.

Note that, the electronic shelf labels 103_1 to 103_N and the management apparatus 107 may transmit and receive information to and from each other by not only Bluetooth, but also wired communication or a combination of wireless and wired communication.

Hereinafter, a “product 102” is a general term for the products 102_1 to 102_N. An “electronic shelf label 103” is a general term for the electronic shelf labels 103_1 to 103_N. A “fixture 104” is a general term for the fixtures 104_1 to 104_4. A “shelf 106” is a general term for the shelves included in the fixtures 104_1 to 104_4. A “product exhibition position 105” is a general term for the product exhibition positions 105_1 to 105_N.

### Functional Configuration of Electronic Shelf Label 103

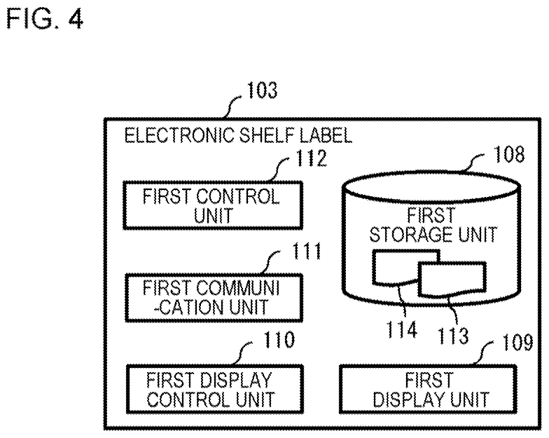

Each electronic shelf label 103 functionally includes a first storage unit 108 as a shelf label storage means, a first display unit 109 as a shelf label display means, a first display control unit 110 as a shelf label display control means, a first communication unit 111, and a first control unit 112, as illustrated in FIG. 4.

The first storage unit 108 stores shelf label product information 113 and shelf label placement information 114.

The shelf label product information 113 is product information of the product 102 associated with the electronic shelf label 103.

The shelf label product information 113 according to the present example embodiment includes, for example, a product identifier (ID), a product name, and a price of the product 102 associated with the electronic shelf label 103.

The product ID is information for identifying the product 102, and is equivalent to product identification information.

Note that, a content of the shelf label product information 113 is not limited thereto, but may be changed as appropriate.

The shelf label placement information 114 is information indicating a position where the electronic shelf label 103 is to be placed. The shelf label placement information 114 according to the present example embodiment indicates, for example, the product exhibition position 105 of the product 102 associated with the electronic shelf label 103. The shelf label placement information 114 according to the present example embodiment indicates a position where the electronic shelf label 103 is to be placed in a diagram illustrating a layout of the fixture 104 in the store 101 as illustrated in FIG. 2 or a configuration of the shelf 106 as illustrated in FIG. 3.

The first display unit 109 displays various kinds of information.

The first display control unit 110 causes the first display unit 109 to display information. The first display control unit 110 causes the first display unit 109 to display, for example, preliminarily determined information of one or both of the shelf label product information 113 and the shelf label placement information 114 in a preliminarily determined form.

The form of display is, for example, a font, a size, and alignment of a letter or a numeral, and illustration used as appropriate. Further, the form of display is, for example, displaying a plurality of pieces of information such as the shelf label product information 113 and the shelf label placement information 114 switchingly at preliminarily determined time intervals.

Specifically, for example, the first display control unit 110 causes the first display unit 109 to graphically display a position where the electronic shelf label 103 is to be placed, by referring to the shelf label placement information 114.

The first communication unit 111 communicates with the management apparatus 107. The first communication unit 111 receives, from the management apparatus 107, for example, the shelf label product information 113, the shelf label placement information 114, various kinds of notifications or instructions, and the like.

The first control unit 112 performs control of the electronic shelf label 103. In the present example embodiment, for example, the first control unit 112 controls the first storage unit 108 and the first communication unit 111.

### Functional Configuration of Management Apparatus 107

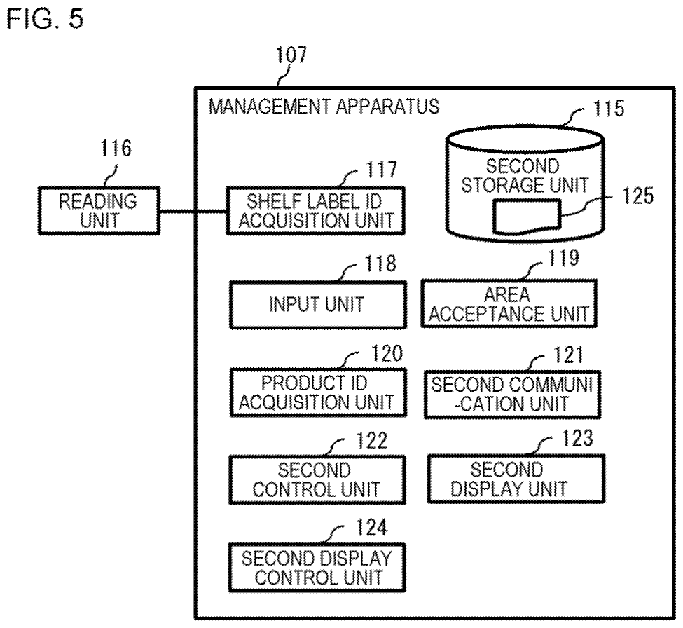

The management apparatus 107 functionally includes a second storage unit 115, a reading unit 116, a shelf label ID acquisition unit 117, an input unit 118, an area acceptance unit 119, a product ID acquisition unit 120 as a product identification information acquisition means, a second communication unit 121, a second control unit 122, a second display unit 123, and a second display control unit 124, as illustrated in FIG. 5.

The second storage unit 115 stores product management information 125 being information in which product information including a product ID, a product name, and a price, exhibition position information, and a shelf label ID are associated with one another for each product 102.

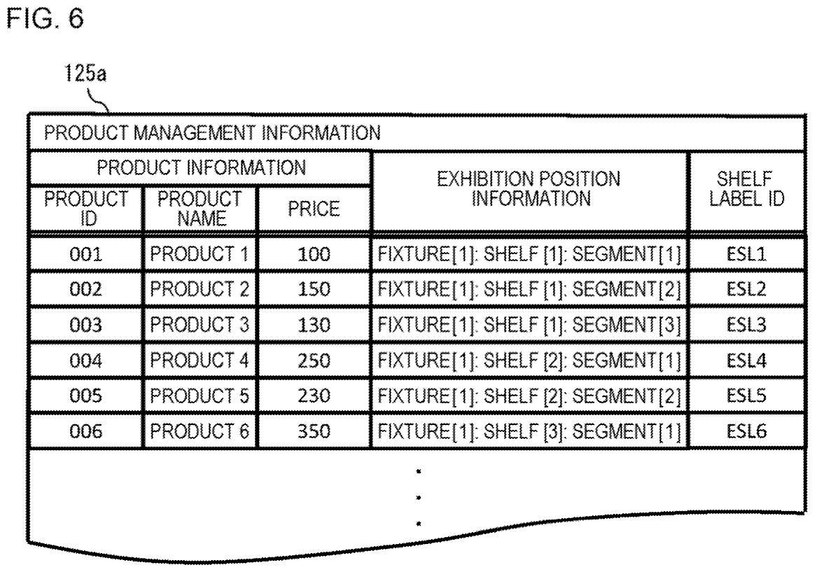

FIG. 6 is a diagram illustrating one example of product management information 125a according to the present example embodiment, and illustrates the product management information 125a relating to the products 102_1 to 102_6.

In the example illustrated in FIG. 6, product IDs “001” to “006” are product IDs of the products 102_1 to 102_6, respectively. For example, product information of the product 102_1 includes a product ID “001”, a product name “product 1”, and a price “100” (yen).

The exhibition position information is information indicating a product exhibition position of the product 102. The exhibition position information according to the present example embodiment includes a fixture ID, a shelf ID, and a segment ID.

The fixture ID is information for identifying the fixture 104, and is equivalent to fixture identification information.

The shelf ID is information for identifying the shelf 106 provided in each of the fixtures 104, and is equivalent to shelf identification information. The shelf ID may not be set for the fixture 104 including no shelf 106.

The segment ID is information for identifying a range allocated to each of the fixtures 104. The range identified by the segment ID serves as a product exhibition position by being associated with the product 102.

The segment ID is assigned, for example, for the fixture 104 including the shelf 106 in such a way that a segment allocated to each of the shelves 106 can be identified. The segment ID is assigned, for example, for the fixture 104 including no shelf 106 in such a way that a segment of the whole fixture 104 can be identified.

In the present example embodiment, the product exhibition position 105_1 of the product 102_1 is a leftmost segment among three segments allocated to the uppermost shelf 106_1 of the fixture 104_1, as illustrated in FIG. 3.

Thus, in the example illustrated in FIG. 6, exhibition position information of the product 102_1 includes a fixture ID “1” of the fixture 104_1, a shelf ID “1” of the uppermost shelf 106_1, and a segment ID “1” of the leftmost segment of the shelf 106_1.

In the example illustrated in FIG. 6, shelf IDs “1” to “3” are respectively information for identifying the shelves 106_1 to 3 of the fixture 104_1.

Further, in the example in FIG. 6, segment IDs “1” to “3” associated with the shelf ID “1” are respectively shelf IDs assigned to three segments (see FIG. 3) allocated to the shelf 106_1 of the fixture 104_1.

Similarly, in the example in FIG. 6, segment IDs “1” and “2” associated with the shelf ID “2” are respectively shelf IDs assigned to two segments (see FIG. 3) allocated to the shelf 106_2 of the fixture 104_1. In the example in FIG. 6, a segment ID “1” associated with the shelf ID “3” is a shelf ID assigned to one segment (see FIG. 3) allocated to the shelf 106_3 of the fixture 104_1.

The product ID, the fixture ID, the shelf ID, and the segment ID according to the present example embodiment are merely one example, and may be preliminarily determined as appropriate.

The shelf label ID is information for identifying each of the electronic shelf labels 103, and is equivalent to shelf label identification information.

The reading unit 116 is a part for reading information, and reads a shelf label ID.

The shelf label ID may be included in, for example, a code such as a barcode or a two-dimensional code indicated on an outer surface of the electronic shelf label 103. Further, for example, the shelf label ID may be held in a radio frequency (RF) tag built in or externally attached to the electronic shelf label 103.

When the shelf label ID is displayed by a code, the reading unit 116 is, for example, a scanner. Further, when the shelf label ID is held in an RF tag, the reading unit 116 is, for example, a radio frequency identifier (RFID) reader.

The shelf label ID acquisition unit 117 acquires a shelf label ID from the reading unit 116.

The input unit 118 is a keyboard, a mouse, a touch sensor, or the like with which a user inputs information.

The area acceptance unit 119 accepts, from the input unit 118, exhibition area information for identifying an exhibition area of one or a plurality of products.

The exhibition area information is information for identifying an exhibition area of one or a plurality of products 102. The exhibition area information according to the present example embodiment is a fixture ID.

Note that, the area acceptance unit 119 may accept the exhibition area information from not only the input unit 118, but also, for example, an external terminal apparatus or the like through an appropriate communication line.

The product ID acquisition unit 120 acquires product information of one or a plurality of products 102 relevant to product identification information associated in the product management information 125 with the exhibition area information accepted by the area acceptance unit 119.

In the present example embodiment, the exhibition area information is a fixture ID as described above, and thus, is included in the exhibition position information of the product management information 125. Then, referring to the exhibition position information of the product management information 125, product identification information of one or a plurality of products 102 exhibited on the fixture 104 identified by the exhibition area information is associated. Thus, the product ID acquisition unit 120 can acquire product information of one or a plurality of products 102 exhibited on the fixture 104 identified by the exhibition area information.

Herein, a plurality of products 102_1 to 102_6 are exhibited on the fixture 104_1 according to the present example embodiment, as described above. Thus, for example, when the exhibition area information accepted by the area acceptance unit 119 is the fixture ID “1” of the fixture 104_1, the product ID acquisition unit 120 is supposed to acquire product information of the plurality of products 102_1 to 102_6.

Only one product 102 may be exhibited on the fixture 104. When the exhibition area information is a fixture ID of the fixture 104 on which only one product 102 is exhibited, the product ID acquisition unit 120 is supposed to acquire product information of the one product 102.

The second communication unit 121 communicates with each of the electronic shelf labels 103. The second communication unit 121 according to the present example embodiment transmits the shelf label product information 113 and the shelf label placement information 114 to the electronic shelf label 103 under control of the second control unit 122.

The second control unit 122 performs control of the management apparatus 107. In the present example embodiment, for example, the second control unit 122 controls the second storage unit 115 and the second communication unit 121.

The second display unit 123 displays various kinds of information.

The second display control unit 124 causes the second display unit 123 to display information. The second display control unit 124 causes the second display unit 123 to display, for example, a layout diagram of the store 101 as illustrated in FIG. 2 or the product exhibition position 105 on the shelf 106 as illustrated in FIG. 3.

A functional configuration of the management system 100 has been mainly described so far. Hereinafter, physical configuration examples of the management apparatus 107 and the electronic shelf label 103 included in the management system 100 will be described with reference to the drawings.

### Physical Configuration of Management Apparatus 107

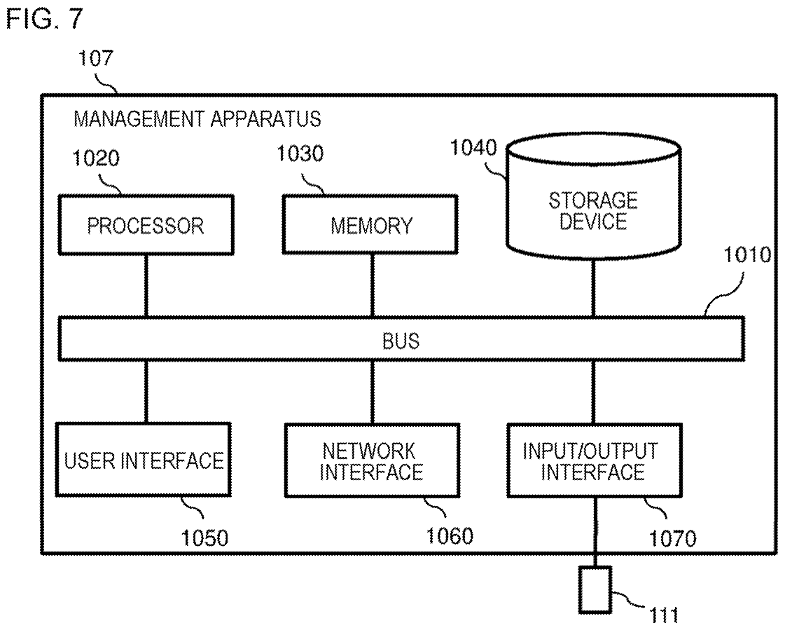

The management apparatus 107 is physically, for example, a general-purpose personal computer, a POS management apparatus, or the like, and includes a bus 1010, a processor 1020, a memory 1030, a storage device 1040, a user interface 1050, a network interface 1060, and an input/output interface 1070, as illustrated in FIG. 7.

The bus 1010 is a data transmission path through which the processor 1020, the memory 1030, the storage device 1040, the user interface 1050, the network interface 1060, and the input/output interface 1070 transmit and receive data to and from one another. However, a method of connecting the processor 1020 and the like with one another is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module for achieving each function of the management apparatus 107. Each of the program modules is read in to the memory 1030 and executed by the processor 1020, and thereby each function unit relevant to the program module is achieved.

The communication interface 1050 is an interface by which the management apparatus 107 receives and transmits information by communication.

The user interface 1050 is equipment or an apparatus on which a user performs input and output. The user interface 1050 includes, as input equipment, for example, the input unit 118 or the like such as a keyboard, a mouse, or a touch sensor. The user interface 1050 includes, as output equipment, for example, a liquid crystal panel or the like.

The input/output interface 1070 is an interface for transmitting and receiving information to and from another equipment such as a scanner or an RFID reader as the reading unit 116.

### Physical Configuration of Electronic Shelf Label 103

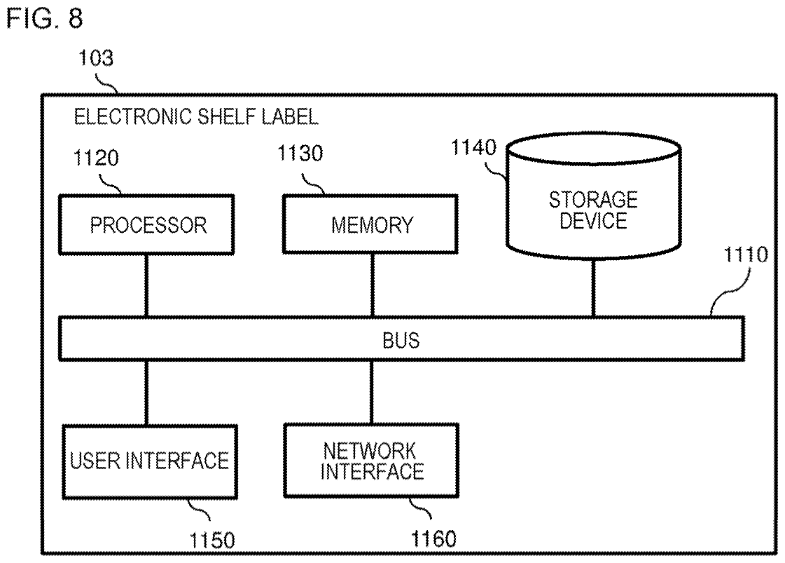

The electronic shelf label 103 physically includes, for example, a bus 1110, a processor 1120, a memory 1130, a storage device 1140, a user interface 1150, and a network interface 1160, as illustrated in FIG. 8.

The bus 1110 is a data transmission path through which the processor 1120, the memory 1130, the storage device 1140, the network interface 1150, and the display device 1160 transmit and receive data to and from one another. However, a method of connecting the processor 1120 and the like with one another is not limited to bus connection.

The processor 1120 is a processor achieved by a CPU, a GPU, or the like. The memory 1130 is a main storage apparatus achieved by a RAM or the like.

The storage device 1140 is an auxiliary storage apparatus achieved by an SSD, a memory card, a ROM, or the like. The storage device 1140 stores a program module for achieving each function of the electronic shelf label 103. Each of the program modules is read in to the memory 1130 and executed by the processor 1120, and thereby each function unit relevant to the program module is achieved.

The network interface 1150 is an interface by which the electronic shelf label 103 receives and transmits information by communication.

The user interface 1150 is a part or an apparatus on which a user performs input and output. The user interface 1150 includes, as an input unit, for example, an operation button, a touch sensor, or the like. The user interface 1150 includes, as output equipment, for example, a liquid crystal panel, an electronic paper, or the like.

A functional and physical configuration of the management system 100 has been described so far. Hereinafter, as an operation of the management system 100, a management method and an electronic shelf label control method will be described with reference to the drawings.

### Operation of Shelf Label Management System 100

### Management Method

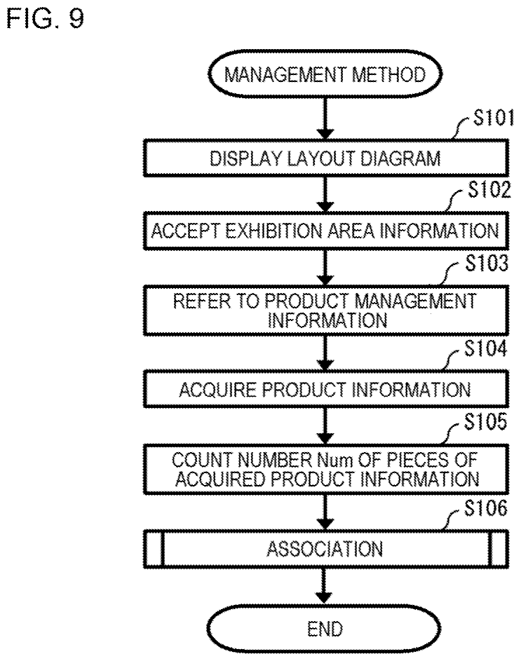

The management method is a method of associating the product 102 and the electronic shelf label 103 with each other. FIG. 9 is a flowchart illustrating the management method according to the present example embodiment.

The management apparatus 107 is started in a state in which a preliminarily determined program is activated and all of the electronic shelf labels 103 are powered on. The management method is performed, for example, in a backroom or the like of the store 101 where the management apparatus 107 is installed.

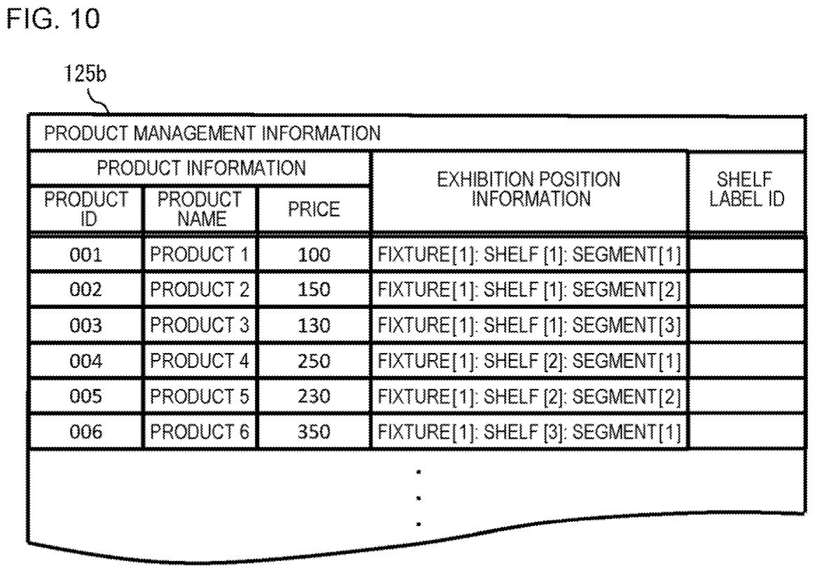

Herein, description will be given by using an example in which product information and exhibition position information of each of the products 102 are set but not a shelf label ID in product management information 125b in an initial state before execution of the management method, as illustrated in FIG. 10. Further, it is assumed that, in the initial state, the first storage unit 108 of all of the electronic shelf labels 103 does not store the shelf label product information 113 and the shelf label placement information 114.

Note that, part or whole of the shelf label IDs in the product management information 125, or part or whole of the shelf label product information 113 and the shelf label placement information 114 may be already set or stored, and may be updated by the management method described below.

The second storage unit 115 preliminarily stores information indicating the layout diagram of the store 101 as illustrated in FIG. 2, and the second display control unit 124 causes the second display unit 123 to display the layout diagram of the store 101 by referring to the information indicating the layout diagram (Step S101).

The area acceptance unit 119 accepts exhibition area information, based on an input of a user to the input unit 118 (Step S102).

Specifically, for example, a user selects, by using a mouse, a touch sensor, or the like, an area where the fixture 104 for placing the electronic shelf label 103 is displayed from a screen on which the layout diagram is displayed in Step S101. Thereby, the area acceptance unit 119 accepts exhibition area information including a fixture ID of the fixture 104 selected by the user.

In this way, a user can easily select the desired fixture 104 by selecting the fixture 104 with reference to the layout diagram.

The product ID acquisition unit 120 refers to the product management information 125 (Step S103).

The product ID acquisition unit 120 acquires product information of one or a plurality of products 102 relevant to the exhibition area information accepted in Step S102, in the product management information 125 referred to in Step S103 (Step S104).

The second control unit 122 counts the number Num of pieces of the product information acquired in Step S104 (Step S105).

The second control unit 122 performs control for associating mutually different electronic shelf labels 103 with first to Num-th products 102 relevant to the product information acquired in Step S104 (Step S106).

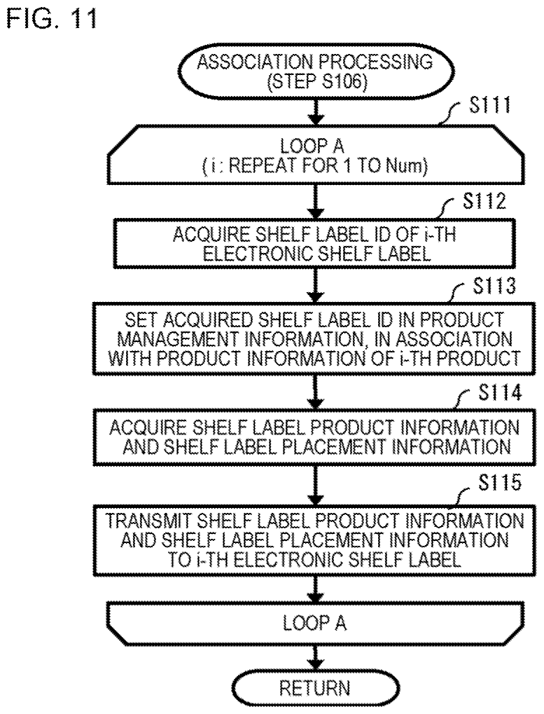

Specifically, in association processing (Step S106), the second control unit 122 repeatedly executes Steps S112 to S115 for each i (i is an integer not less than 1 but not more than Num.) from 1 to Num (loop A: Step S111), as illustrated in FIG. 11.

The shelf label ID acquisition unit 117 acquires a shelf label ID of an i-th electronic shelf label 103 (Step S112).

More specifically, for example, a user holds the reading unit 116 over the electronic shelf label 103 with which the product 102 has not yet been associated. Thereby, a shelf label ID of the electronic shelf label 103 is read by the reading unit 116, and the shelf label ID acquisition unit 117 acquires the shelf label ID from the reading unit 116.

The second control unit 122 sets the shelf label ID acquired in Step S112 in the product management information 125, in association with product information of an i-th product (Step S113).

The second control unit 122 refers to the product management information 125, acquires the product information of the i-th product for which the shelf label ID is set in Step S113 as the shelf label product information 113, and acquires exhibition position information of the i-th product as the shelf label placement information 114 (Step S114).

Note that, the shelf label product information 113 may be part (for example, a product name and a price) whole of information included in product information of the product management information 125, and the shelf label placement information 114 may be part (for example, a fixture ID, a shelf ID, or a fixture ID and a shelf ID) of exhibition position information or may be the exhibition area information accepted in Step S102.

The second communication unit 121 transmits, under control of the second control unit 122, the shelf label product information 113 and the shelf label placement information 114 acquired in Step S114 to the i-th electronic shelf label 103 (Step S115).

When Steps S112 to S115 as described above are executed for each of the first to Num-th products exhibited in an exhibition area identified by the exhibition area information accepted in Step S102, the second control unit 122 ends the loop A (Step S111). With this, the association processing (Step S106) also ends. Then, the second control unit 122 ends the management method, as illustrated in FIG. 9.

By executing the management method as described above, shelf label IDs of first to Num-th electronic shelf labels 103 are set in the product management information 125, in association with product information of the first to Num-th products, respectively.

For example, when the fixture ID “1” of the fixture 104_1 is selected as exhibition area information, shelf label IDs “EST 1” to “EST6” of first to sixth electronic shelf labels 103 are set in association with the products 102_1 to 102_6, respectively, exhibited on the fixture 104_1, as illustrated in FIG. 6.

The first to Num-th products 102 exhibited in an exhibition area are thus associated with the first to Num-th electronic shelf labels 103 in the management apparatus 107.

### Electronic Shelf Label Control Method

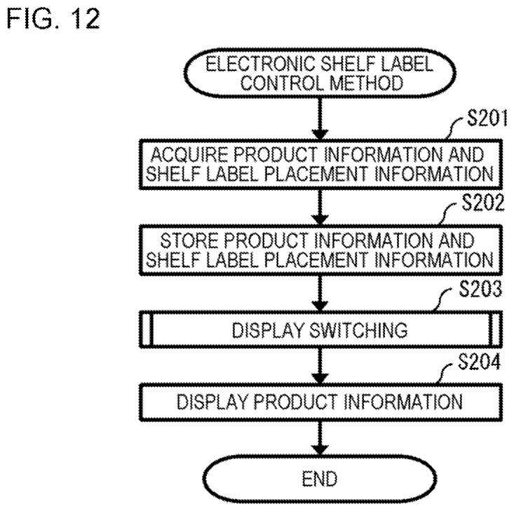

The electronic shelf label control method is a method for controlling the electronic shelf label 103, and is executed in each of the electronic shelf labels 103. FIG. 12 is a flowchart illustrating one example of the electronic shelf label control method according to the present example embodiment.

The electronic shelf label control method is started, for example, in the i-th electronic shelf label 103 when the shelf label product information 113 and the shelf label placement information 114 are transmitted to the i-th electronic shelf label 103 in Step S115 of the management method.

When the first communication unit 111 receives the shelf label product information 113 and the shelf label placement information 114 from the management apparatus 107, the first control unit 112 acquires the shelf label product information 113 and the shelf label placement information 114 via the first communication unit 111 (Step S201)

The first control unit 112 stores, in the first storage unit 108, the shelf label product information 113 and the shelf label placement information 114 acquired in Step S201 (Step S202).

The shelf label product information 113 and the shelf label placement information 114 are thus stored in the first storage unit 108 of the i-th electronic shelf label 103.

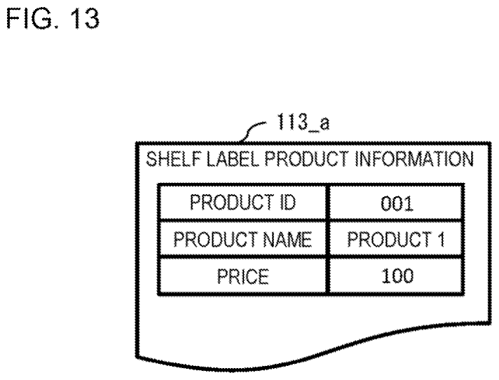

FIG. 13 is a diagram illustrating one example of shelf label product information 113_a stored in the first storage unit 108 of the electronic shelf label 103_1 according to the present example embodiment.

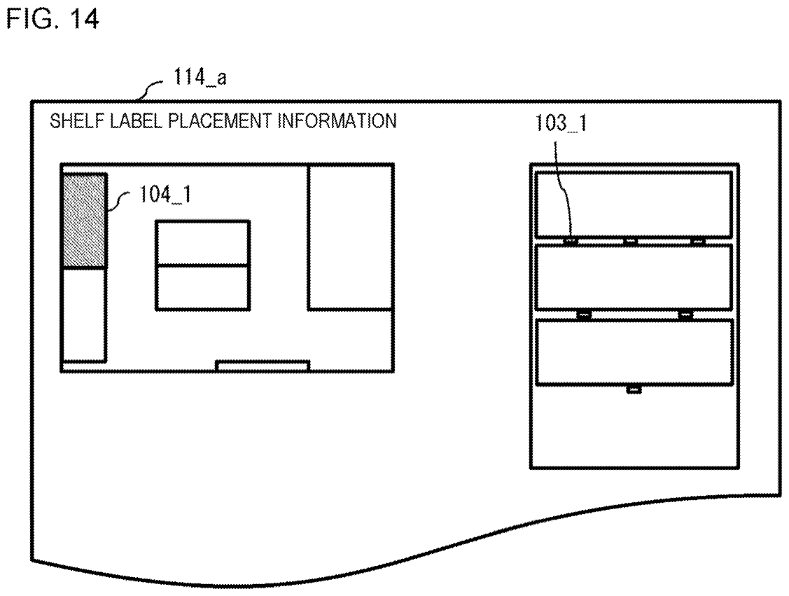

Further, FIG. 14 is a diagram illustrating one example of shelf label placement information 114_a stored in the first storage unit 108 of the electronic shelf label 103_1 according to the present example embodiment. As illustrated in the figure, the shelf label placement information 114_a according to the present example embodiment includes a diagram illustrating a layout of the fixture 104 in the store 101 and a configuration of the shelf 106 in the fixture 104, thereby graphically indicating a position where the electronic shelf label 103_1 is to be attached.

The shelf label placement information 114 a illustrated in FIG. 14 includes two left and right diagrams, and the left diagram indicates a position of the fixture 104_1 to which the electronic shelf label 103_1 is to be attached in a layout diagram of the store 101. In the figure, the position of the fixture 104_1 is indicated by hatching, but a method of indicating the position of the fixture 104_1 may be changed as appropriate.

The right diagram included in the shelf label placement information 114_a indicates that the electronic shelf label 103_1 is attached in association with the product exhibition position 105_1 of the product 102_1 in a configuration diagram of the shelf 106 of the fixture 104_1. In the figure, a position where the electronic shelf label 103_1 is to be attached in the fixture 104_1 is indicated by hatching, but a method of indicating the position may be changed as appropriate.

Note that, the shelf label placement information 114 may indicate the product exhibition position 105 of the product 102 with which the electronic shelf label 103 is associated, by using, for example, a letter, a symbol, and the like representing a fixture ID, a shelf ID, and a segment ID.

The first display control unit 110 causes the first display unit 109 to switchingly display the shelf label product information 113 and the shelf label placement information 114 stored in the first storage unit 108 by executing Step S202 (Step S203).

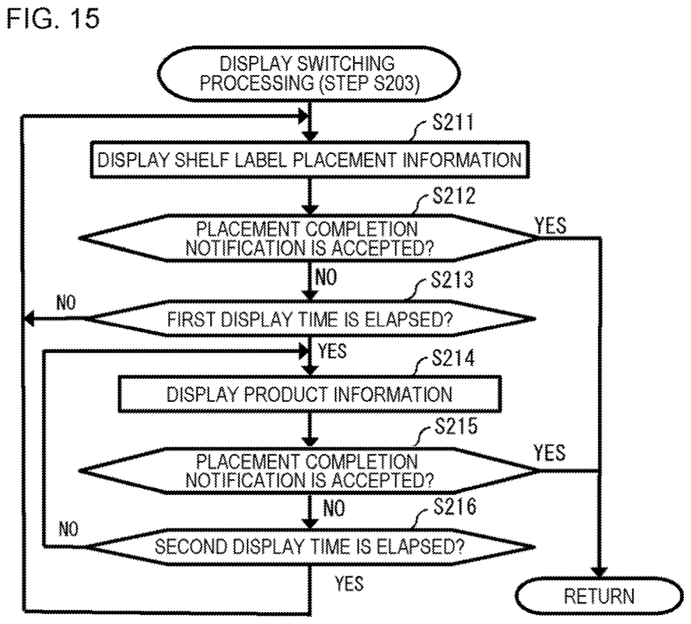

Specifically, in display switching processing (Step S203), the first display control unit 110 causes the first display unit 109 to display the shelf label placement information 114 (Step S211), as illustrated in a flowchart in FIG. 15.

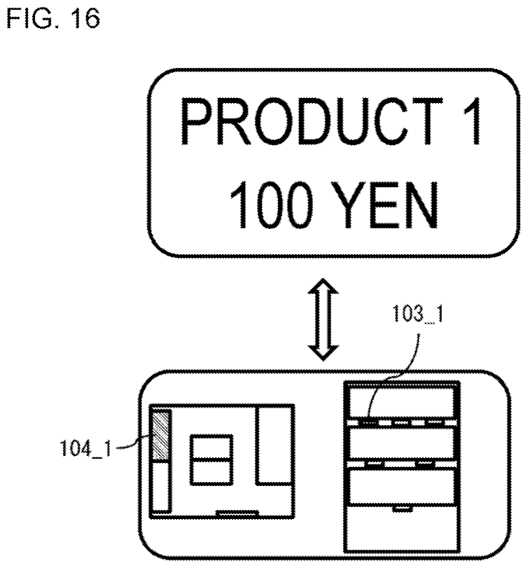

For example, in Step S211, the first display control unit 110 causes the first display unit 109 to display a screen illustrated in a lower diagram in FIG. 16. The lower diagram in FIG. 16 is relevant to a content of the shelf label placement information 114_a described with reference to FIG. 14.

Note that, the shelf label placement information displayed in Step S211 is not limited to whole of the shelf label placement information 114 stored in the first storage unit 108, but may be part of the shelf label placement information 114 (for example, only a position of the fixture 104 to which the electronic shelf label 103 is attached, or the like).

The first display control unit 110 determines whether a placement completion notification has been accepted (Step S212).

The placement completion notification is a notification indicating that placing the electronic shelf label 103 at a position indicated by the shelf label placement information is completed by attaching the electronic shelf label 103 to the fixture 104. The placement completion notification is accepted by the first display control unit 110, for example, by a user depressing a button provided on the electronic shelf label 103 when placement of the electronic shelf label 103 is completed.

Note that, the placement completion notification may be acquired by an operation or the like of a user on a terminal apparatus that can communicate with the electronic shelf label 103.

When determining that the placement completion notification has not been accepted (Step S212; NO), the first display control unit 110 determines whether first display time has elapsed after start of Step S211 (Step S213).

The first display time is a period of time preliminarily determined as time for displaying the shelf label placement information 114 in the display switching processing (Step S203).

When determining that the first display time has not elapsed (Step S213; NO), the first display control unit 110 causes the first display unit 109 to continuingly display the shelf label placement information 114 (Step S211).

When determining that the first display time has elapsed (Step S213; YES), the first display control unit 110 causes the first display unit 109 to display product information included in the shelf label product information 113 (Step S214).

For example, in Step S214, the first display control unit 110 causes the first display unit 109 to display a screen illustrated in an upper diagram in FIG. 16. The upper diagram in FIG. 16 illustrates an example in which a product name and a price in the shelf label product information 113_a described with reference to FIG. 13 are displayed on a screen as product information.

Note that, the product information displayed in Step S214 is not limited to part of the shelf label product information 113, but may be whole of the shelf label product information 113.

The first display control unit 110 determines whether the placement completion notification has been accepted, similarly to Step S212 (Step S215).

When determining that the placement completion notification has not been accepted (Step S215; NO), the first display control unit 110 determines whether second display time has elapsed after start of Step S214 (Step S216).

The second display time is a period of time preliminarily determined as time for displaying the shelf label product information 113 in the display switching processing (Step S203). The second display time may be the same as the first display time, or may be different from the first display time.

When determining that the second display time has not elapsed (Step S216; NO), the first display control unit 110 causes the first display unit 109 to continuingly display the shelf label product information 113 (Step S211).

When determining that the second display time has elapsed (Step S216; YES), the first display control unit 110 causes the first display unit 109 to display the shelf label placement information 114 again (Step S211).

When determining that the placement completion notification has been accepted in response to depression of a button or the like (Step S212; YES or Step S216; YES), the first display control unit 110 ends the display switching processing (Step S203).

Then, returning to the electronic shelf label control method illustrated in FIG. 12, the first display control unit 110 ends the display of the shelf label placement information 114, displays product information similarly to Step S214 (Step S204), and ends the electronic shelf label control method.

By executing the electronic shelf label control method as described above, the shelf label product information 113 is stored and the product 102 is associated with the electronic shelf label 103.

In the present example embodiment, since the exhibition area information is a fixture ID, the management method may be executed for each of the fixtures 104_1 to 104_4 installed in the store 101. The electronic shelf label control method is executed according to the management method. The products 102_1 to N and the electronic shelf labels 103_1 to N are thus associated with each other.

One example embodiment of the present invention has been described so far.

According to the present example embodiment, the product 102 and the electronic shelf label 103 are associated with each other for each exhibition area (in the present example embodiment, the fixture 104) of the product 102.

Since the electronic shelf label 103 can be thus managed and placed for each exhibition area, labor of finding out the electronic shelf label 103 to be placed on an exhibition area from among all of the electronic shelf labels 103 to be placed in the store 101 can be reduced.

Accordingly, labor of a user when placing the electronic shelf label 103 on the fixture 104 can be reduced.

According to the present example embodiment, since the shelf label placement information 114 is displayed on the first display unit 109, a user can easily place the electronic shelf label 103 with reference to the first display unit 109. Accordingly, labor of a user when placing the electronic shelf label 103 on the fixture 104 can be reduced.

In particular, in the present example embodiment, a position where the electronic shelf label 103 is to be placed is illustrated on a screen together with a layout diagram of the store 101, a configuration diagram of the fixture 104, or the like. Thus, a user can easily recognize a position where the electronic shelf label 103 is to be placed. Accordingly, labor of a user when placing the electronic shelf label 103 on the fixture 104 can be further reduced.

Furthermore, according to the present example embodiment, the shelf label placement information 114 and product information are switchingly displayed on the first display unit 109 until a placement completion notification is accepted. This enables a user to easily check, when attaching the electronic shelf label 103 to the fixture 104, not only a position where the electronic shelf label 103 is to be placed, but also consistency between the product 102 associated with the electronic shelf label 103 and the product 102 exhibited on the fixture 104. Accordingly, labor of a user when placing the electronic shelf label 103 on the fixture 104 can be further reduced.

Furthermore, according to the present example embodiment, upon acceptance of a placement completion notification, display of the shelf label placement information 114 is ended and product information is continuingly displayed on the first display unit 109. This enables the electronic shelf label 103 to easily function as a shelf label for the associated product 102. Accordingly, labor of a user when placing the electronic shelf label 103 on the fixture 104 can be further reduced.

The present invention is not limited to one example embodiment. The example embodiment may be modified, for example, as follows.

### Modified Example 1

For example, exhibition area information is not limited to a fixture ID, but may be a shelf ID. In this case, the area acceptance unit 119 may accept a shelf ID as exhibition area information in Step S102.

Specifically, for example, the area acceptance unit 119 may display, as a screen on which the shelf 106 of the fixture 104 selected by using the layout diagram (see FIG. 2) in Step S101 is displayed, a placement diagram (see FIG. 3) of the shelf 106 in the fixture 104. Then, the area acceptance unit 119 may accept exhibition area information including a shelf ID of the shelf 106 selected by a user from the displayed placement diagram of the shelf 106.

For example, since three products 102_1 to 102_3 are exhibited on the shelf 106_1 of the fixture 104_1, when exhibition area information is the shelf ID “1” of the shelf 106_1, products relevant to the exhibition area information are the products 102_1 to 102_3. Further, for example, since one product 102_6 is exhibited on the shelf 106_3 of the fixture 104_1, when exhibition area information is the shelf ID “3” of the shelf 106_3, a product relevant to the exhibition area information is the product 102_6.

This also exhibits an advantageous effect similar to the example embodiment.

### Modified Example 2

For example, a method of acquiring a shelf label ID in Step S112 is not limited to a method using the reading unit 116.

For example, a shelf label ID may be stored in the first storage unit 108, and the shelf label ID acquisition unit 117 may acquire, automatically or according to selection by a user, a shelf label ID of the electronic shelf label 103 with which the product 102 has not yet been associated.

In this case, in order that a user can recognize to which electronic shelf label 103 the acquired shelf label ID is relevant, an informing instruction for a user may be performed from the management apparatus 107 to the electronic shelf label 103 relevant to the shelf label ID. Then, the electronic shelf label 103 receiving the informing instruction may inform a user of the electronic shelf label 103 to be processed, by a preliminarily determined method.

For example, when the electronic shelf label 103 includes a speaker, a light-emitting unit such as a light-emitting diode, or a vibrating unit for causing vibration, the informing may be performed by using sound, light, or vibration. Further, a user may be informed by display on the first display unit 109.

This also exhibits an advantageous effect similar to the example embodiment.

### Modified Example 3

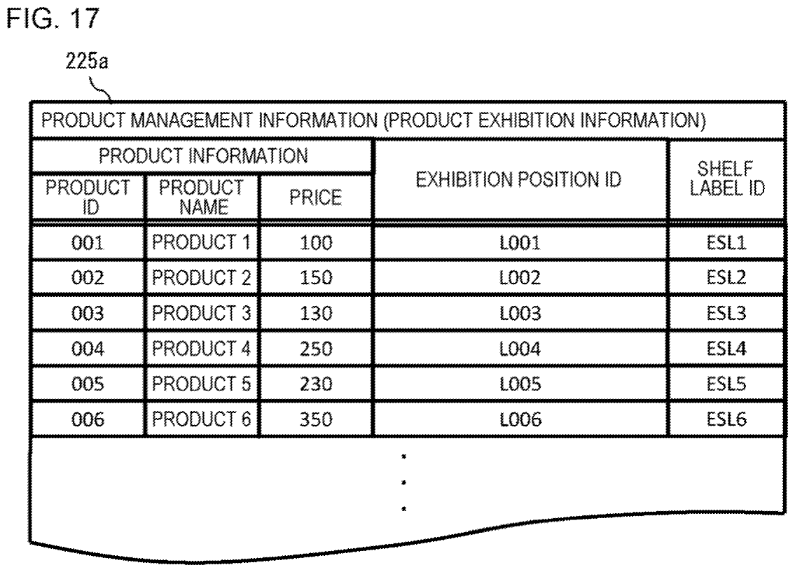

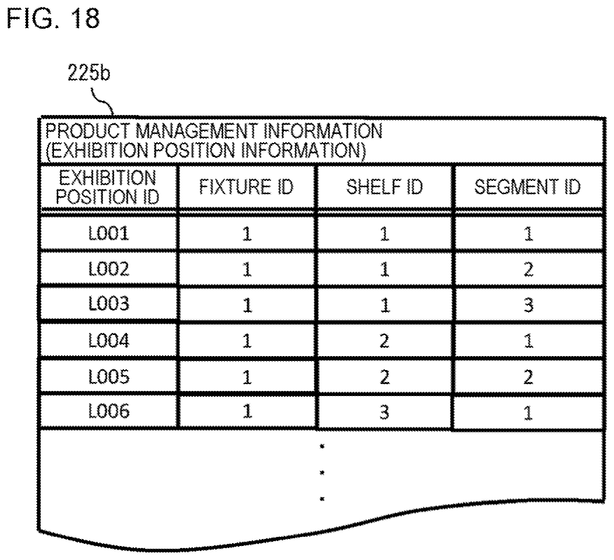

For example, the product management information 125 may be constituted of a plurality of pieces of information. FIGS. 17 and 18 illustrate one example of product exhibition information 225a and exhibition position information 225b constituting product management information according to a modified example 3.

The product exhibition information 225a includes an exhibition position ID instead of exhibition position information included in the product management information 125 according to the example embodiment, as illustrated in FIG. 17. The exhibition position ID is information for identifying a range where the product 102 is exhibited.

The exhibition position information 225b is information in which an exhibition position ID, a fixture ID, a shelf ID, and a segment ID are associated with one another, as illustrated in FIG. 18.

In other words, the product management information according to the present modified example is constituted of the product exhibition information 225a and the exhibition position information 225b associated with each other by an exhibition position ID.

This also exhibits an advantageous effect similar to the example embodiment.

Furthermore, while a plurality of processes (pieces of processing) are described in order in the diagram illustrating a flow used in the above description, execution order of the processes is not limited to the described order. The order of the processes can be changed, as long as the change does not detract from contents. Further, the above example embodiment and the modified examples can be combined, as long as contents do not contradict each other.

The whole or part of the above-described example embodiment can be described as, but not limited to, the following supplementary notes.

1. A management apparatus including:
a product identification information acquisition means for acquiring, when accepting exhibition area information for identifying an exhibition area of one or a plurality of products, product information of the one or a plurality of products relevant to product identification information associated with the accepted exhibition area information in information in which exhibition area information and product identification information are associated with each other; and
a control means for performing control for associating each of the one or a plurality of pieces of acquired product information with one or a plurality of display apparatuses.

2. The management apparatus according to supplementary note 1, wherein
the exhibition area information is fixture identification information for identifying a fixture on which the product is exhibited, or shelf identification information for identifying a shelf provided in each of the fixtures.

3. The management apparatus according to supplementary note 2, further including
an area acceptance means for accepting the exhibition area information, wherein
the area acceptance means accepts, as the exhibition area information, a fixture selected by a user from a screen displaying a layout of a fixture in the store or a shelf selected by a user from a screen displaying a shelf of the selected fixture.

4. The management apparatus according to any one of supplementary notes 1 to 3, wherein
the control means associates, in addition to the one or a plurality of pieces of product information, shelf label placement information indicating a position where the electronic shelf label is to be placed, with the one or a plurality of electronic shelf labels, and
the shelf label placement information is exhibition position information indicating an exhibition position of a product relevant to the product information or the accepted exhibition area information.

5. An electronic shelf label including:
a shelf label storage means for storing product information and shelf label placement information indicating a position to be placed; and
a shelf label display control means for causing a shelf label display means to display the shelf label placement information, wherein
the shelf label placement information is fixture identification information for identifying a fixture on which the product is exhibited, shelf identification information for identifying a shelf provided in each of the fixtures, or exhibition position information indicating an exhibition position of a product.

6. The electronic shelf label according to supplementary note 5, wherein
the shelf label placement information includes information indicating the position to be placed in a diagram illustrating a layout of the fixture in a store, and
a shelf label display control means causes the shelf label display means to graphically display the position to be placed by referring to the shelf label placement information.

7. The electronic shelf label according to supplementary note 5 or 6, wherein
the shelf label display control means further causes the shelf label display means to display the product information.

8. The electronic shelf label according to supplementary note 7, wherein
a shelf label display control means causes the shelf label display means to switchingly display the product information and the shelf label placement information until a predetermined placement completion notification is accepted, and ends display of the shelf label placement information when the placement completion notification is accepted.

9. A management system including:
one or a plurality of electronic shelf labels; and
a management apparatus that manages the one or a plurality of electronic shelf labels, wherein
the management apparatus includes
   a product identification information acquisition means for acquiring, when accepting exhibition area information for identifying an exhibition area of one or a plurality of products, product information of the one or a plurality of products relevant to product identification information associated with the accepted exhibition area information in information in which exhibition area information and product identification information are associated with each other, and
   a registration control means for performing control for associating each of the one or a plurality of pieces of product information with the one or a plurality of electronic shelf labels.

10. A management method including:
acquiring, when accepting exhibition area information for identifying an exhibition area of one or a plurality of products, product information of the one or a plurality of products relevant to product identification information associated with the accepted exhibition area information in information in which exhibition area information and product identification information are associated with each other; and
performing control for associating each of the one or a plurality of pieces of acquired product information with one or a plurality of display apparatuses.

11. A program causing a computer to execute:
acquiring, when accepting exhibition area information for identifying an exhibition area of one or a plurality of products, product information of the one or a plurality of products relevant to product identification information associated with the accepted exhibition area information in information in which exhibition area information and product identification information are associated with each other; and
performing control for associating each of the one or a plurality of pieces of acquired product information with one or a plurality of display apparatuses.

12. An electronic shelf label control method for controlling an electronic shelf label that includes a shelf label storage means for storing product information and shelf label placement information indicating a position to be placed, the electronic shelf label control method including
causing a shelf label display means to display the shelf label placement information, wherein
the shelf label placement information is fixture identification information for identifying a fixture on which the product is exhibited, shelf identification information for identifying a shelf provided in each of the fixtures, or exhibition position information indicating an exhibition position of a product

13. A program causing a computer to execute:
storing, in a storage means, product information and shelf label placement information indicating a position to be placed; and
causing a shelf label display means to display the shelf label placement information, wherein
the shelf label placement information is fixture identification information for identifying a fixture on which the product is exhibited, shelf identification information for identifying a shelf provided in each of the fixtures, or exhibition position information indicating an exhibition position of a product.

### REFERENCE SIGNS LIST

100 Management system

101 Store

102, 102_1 to 102_N Product

103, 103_1 to 103_N Electronic shelf label

104, 104_1 to 104_4 Fixture

105, 105_1 to 105_N Product exhibition position

106, 106_1 to 106_3 Shelf

107 Management apparatus

108 First storage unit

109 First display unit

110 First display control unit

111 First communication unit

112 First control unit

113, 113_a Shelf label product information

114, 114_a Shelf label placement information

115 Second storage unit

116 Reading unit

117 Shelf label ID acquisition unit

118 Input unit

119 Area acceptance unit

120 Product ID acquisition unit

121 Second communication unit

122 Second control unit

123 Second display unit

124 Second display control unit

125, 125a, 125b Product management information

225a Product exhibition information

225b Exhibition position information

What is claimed is:

1. A management apparatus comprising:
at least one memory configured to store instructions; and
at least one processor configured to execute the instructions to perform operations comprising:
acquiring, when accepting exhibition area information for identifying an exhibition area of one or a plurality of products, product information of the one or a plurality of products relevant to product identification information associated with the accepted exhibition area information in information in which exhibition area information and product identification information are associated with each other; and
performing control for associating each of the one or a plurality of pieces of acquired product information with one or a plurality of display apparatuses.

2. The management apparatus according to claim 1, wherein
the exhibition area information is fixture identification information for identifying a fixture on which the product is exhibited, or shelf identification information for identifying a shelf provided in each of the fixtures.

3. The management apparatus according to claim 2, further comprising
accepting the exhibition area information, wherein
the exhibition area information includes an information related to a fixture selected by a user from a screen displaying a layout of a fixture in a store or a shelf selected by a user from a screen displaying a shelf of the selected fixture.

4. The management apparatus according to claim 1, wherein
performing control includes associating, in addition to the one or a plurality of pieces of product information, shelf label placement information indicating a position where one or a plurality of electronic shelf labels is to be placed, with the one or a plurality of electronic shelf labels, and
the shelf label placement information is exhibition position information indicating an exhibition position of a product relevant to the product information or the accepted exhibition area information.

5. An electronic shelf label comprising:
at least one memory configured to store instructions; and
at least one processor configured to execute the instructions to perform operations comprising:
storing product information and shelf label placement information indicating a position to be placed; and
causing shelf label display to display the shelf label placement information, wherein
the shelf label placement information includes fixture identification information for identifying a fixture on which a product is exhibited, shelf identification information for identifying a shelf provided in each of the fixtures, or exhibition position information indicating an exhibition position of a product.

6. The electronic shelf label according to claim 5, wherein
the shelf label placement information includes information indicating the position to be placed in a diagram illustrating a layout of the fixture in a store, and
causes causing the shelf label display to graphically display the position to be placed by referring to the shelf label placement information.

7. The electronic shelf label according to claim 5, wherein
causing further the shelf label display to display the product information.

8. The electronic shelf label according to claim 7, wherein
causing the shelf label display to switchingly display the product information and the shelf label placement information until a predetermined placement completion notification is accepted, and to end display of the shelf label placement information when the placement completion notification is accepted.

9. (canceled)

10. A management method comprising:
acquiring, when accepting exhibition area information for identifying an exhibition area of one or a plurality of products, product information of the one or a plurality of products relevant to product identification information associated with the accepted exhibition area information in information in which exhibition area information and product identification information are associated with each other; and
performing control for associating each of the one or a plurality of pieces of acquired product information with one or a plurality of display apparatuses.

11. (canceled)
